(19) United States
(12) Patent Application Publication
(10) Pub. No.: US 2014/0160996 A1
(43) Pub. Date: Jun. 12, 2014

(54) SYSTEM AND METHOD FOR DECENTRALIZED VOICE CONFERENCING OVER DYNAMIC NETWORKS

(71) Applicant: Rajant Corporation, Malvern, PA (US)

(72) Inventors: Paul R. Hellhake, Downingtown, PA (US); David ACKER, Malvern, PA (US); Jonathan WURTZ, Bryn Mawr, PA (US); David B. HAYNIE, Monroeville, NJ (US); Keith SULLIVAN, West Chester, PA (US)

(73) Assignee: Rajant Corporation, Malvern, PA (US)

(21) Appl. No.: 14/074,363

(22) Filed: Nov. 7, 2013

Related U.S. Application Data
(60) Provisional application No. 61/734,734, filed on Dec. 7, 2012.

(51) Int. Cl. H04L 29/06; H04W 4/08; H04L 12/18

(52) U.S. Cl. CPC H04L 65/4053; H04L 12/185; H04W 4/08
USPC 370/261

(57) ABSTRACT

Systems, devices, methods for use of a highly mobile conferencing system over potentially dynamic networks, such as a self-healing mobile mesh network which, by means of discrete embedded computers mixes analog and digital data for end user communications in remote, disaster, warfare or topographically challenging environments with further capability of conference calling between groups and discrete nodes within the network.

### REFERENCE TO RELATED APPLICATION

The present application claims the benefit of U.S. Provisional Patent Application No. 61/734,734, filed Dec. 7, 2012, whose disclosure is hereby incorporated by reference in its entirety into the present disclosure.

### FIELD OF THE INVENTION

The present invention concerns tactical and other highly mobile communications networks. Such networks are distinguished by their ability to self-organize and heal connections, as radio nodes enter and leave each others' direct communications ranges without impacting the performance of other elements of the network. This invention is also concerned with voice teleconferencing over digital networks.

### DISCUSSION OF THE KNOWN ART

Classic voice radio communications, while very useful, suffer from the limitations inherent in analog radio. An analog radio is usually designed for a single type of communications, such as voice, with no flexibility on data communications, and more importantly, no flexibility within the analog protocol. Radio users sharing a channel are inherently “conferencing,” in modern terms.

Such conferences are extremely limited compared to our experience with online and other digital conferencing experiences. Analog radio conferences are usually very susceptible to radio band noise. The only way to carry on multiple, separate conferences is by changing radio channels. Changing channels is a hardware decision, which makes the notion of flexible conferencing, with multiple users each participating in multiple, independent conference groups, impractical. In addition, classic analog voice radio communications are only functional when each radio can hear every other radio in a conference. There are no redundancy, no repeaters, etc. An analog radio conference also has little or very weak security.

Thus, radio voice conferencing can be greatly enhanced by building a voice conferencing system on a modern digital network radio. This is in practice what many existing conferencing systems have done, both in traditional Public Switched Telephone Network (PSTN) telecommunications providers and, more recently, online and other forms of Internet Protocol (IP) conferencing. The tradition of these various protocols is to present centralized servers for client rendezvous, both for directory services and for the conferencing aggregation itself.

For highly mobile radio communications, however, the analog solution has still often been the choice over a digital system, for a simple reason: it is decentralized. There is no need for a central server in an analog radio conference, so if any participant in a conference loses signal, that affects only that participant. The conference itself is maintained. But for a typical centrally managed digital voice conference, losing that central resource nullifies the whole conference.

### SUMMARY OF THE INVENTION

It is therefore an object of the invention to combine the advantages of analog and digital conferencing in order to overcome the disadvantages of both.

To achieve the above and other objects, an improvement to the art is described herein. This presents a digital voice conferencing system as a group of peer network nodes. The need for digital mixing of conference audio can be managed by any node in the network. New protocols allow the mixing node to be selected and re-selected, as nodes dynamically enter or leave the network. While not critical to its operation, in the preferred implementation, the conferencing system (dubbed TRoIP—Tactical Radio over Internet Protocol) runs over a mesh-based network. The mesh improves the radio's performance, and consequently the network's performance, versus a non-mesh implementation, allowing a conference to continue as long as each radio can hear at least one other radio, and there is some path from each radio to the other, either directly, through other radios, or through repeaters. This method also encapsulates the conference in any security applied at the network layer.

A self-configuring voice conferencing network capability is described that may be superimposed over wired networks, wireless networks, or combinations thereof. The voice conferencing network removes the requirement of using a fixed centralized VoIP registrar, such as a SIP server, or conferencing server. In particular, such a system is well suited to the realities of a highly mobile IP mesh network. As described herein, a local network cluster of voice enabled nodes will form a voice conference with one another over the mobile network at the direction of a participating node that has the role of conference server/mixing node, or Mix-Master.

When a conference is started, every node in the conference will participate in an election to select a Mix-Master node. In this process, each participating node in the network transmits an election bid message packet containing its election score, VoIP callback address and addressing information. The election message is sent to the multicast address configured for said node's conference or Call Group. Each node will then receive all other nodes' election bid messages from the IP multicast address. Each node will evaluate all bids received during the election cycle, along with its own bid. The single node in the cluster with the highest election score is assigned the role of Mix-Master for the network. All other nodes in the cluster will initiate a VoIP call to the conference server, thus eliminating the traditional need for a centralized server. The election process is repeated by each node in the Call Group continually.

Call groups are pre-configured independent voice conferences on all voice enabled nodes. Each voice enabled node is configured with the unique multicast addresses assigned to each of the call groups of which the node is a member. The node determines which call groups to join via a user interface (UI). If two or more nodes become isolated from the other participating nodes in a Call Group, those isolated nodes will form a new instance of said Call Group, and the election process is repeated among said nodes.

Part of this system is a Push-to-Talk interface. This incorporates the client software mixer and a hardware module. The hardware module provides the digital interface to the user, ADC for microphone and and DAC for speaker/headset. The interface controls microphone bias, reads the PTT button, and optionally implements a secondary audio interface. The secondary interface includes audio in and out connections and a switch, to allow the user to choose between the network radio and a second communications device, such as a cellphone or analog radio, using the same headset.

Every participating node in a given Call Group will mix network audio to the PTT interface/headset, based on the rules set up for the specific Call Group. This can involve directing different conversations to different channels (left/right) on the headset, and directing microphone audio back to the selected Call Group. An elected Call Group Mix-Master node will run in a different mode, the precise nature of which depends on other details of the configuration, such as point-to-point versus broadcast settings.

The system configuration tool allows any number of voice-enabled nodes to be preconfigured or reconfigured for any given call group at any time a connection is present. Each node may be assigned to multiple call groups. Multiple and different Call Groups can be sent to the left or right side headphone, mixed as necessary with each other and audio user interface output, such as alarm, alert, and navigation tones locally generated on the network node in response to network events of various types.

The invention is contemplated for use in remote, topographically evolving or challenging environments, disaster, military and diverse environments that require reliable secure data and analog communications between groups of people with limited or no infrastructure to support traditional communication methodologies.

### BRIEF DESCRIPTION OF THE DRAWINGS

For a better understanding of the invention, reference is made to the following description taken in conjunction with the accompanying drawings and the appended claims. The objects, features, and advantages of the present invention will be apparent to those skilled in the art in light of the following detailed description of the invention in which:

FIG. 1 shows an example of a typical TRoIP system using mesh networking radios;

FIGS. 2a-2f illustrate a number of possible configurations of a TRoIP node, with the flexible mixer blocks in various different configuration;

FIG. 3 is a diagram of the local audio mixer in a node;

FIG. 4 is a diagram of the flexible mixer block in local mix mode;

FIG. 5 is a diagram of the flexible mixer block in Unicast Mix-Master mode;

FIG. 6 is a diagram of the flexible mixer block in Multicast Mix-Master mode;

FIG. 7 is a diagram of the Push-to-Talk (PTT) hardware interface;

FIG. 8 is a block diagram of the Conference Server Election Cycle; and

FIG. 9 is a block diagram of the Conference Server Change Routine.

### DETAILED DESCRIPTION OF THE PREFERRED EMBODIMENT

A preferred embodiment of the present invention will be disclosed with reference to the drawings, in which like reference numerals refer to like elements or steps throughout.

Given a digital computer networking system, the preferred embodiment (dubbed Tactical Radio over Internet Protocol, or TRoIP) implements a flexible audio conferencing system. This conferencing system works across any peer-to-peer network, no central server or master node is required. The design is also able to deal with active mesh networks, which in a highly mobile environment may be adding and dropping nodes on a regular basis.

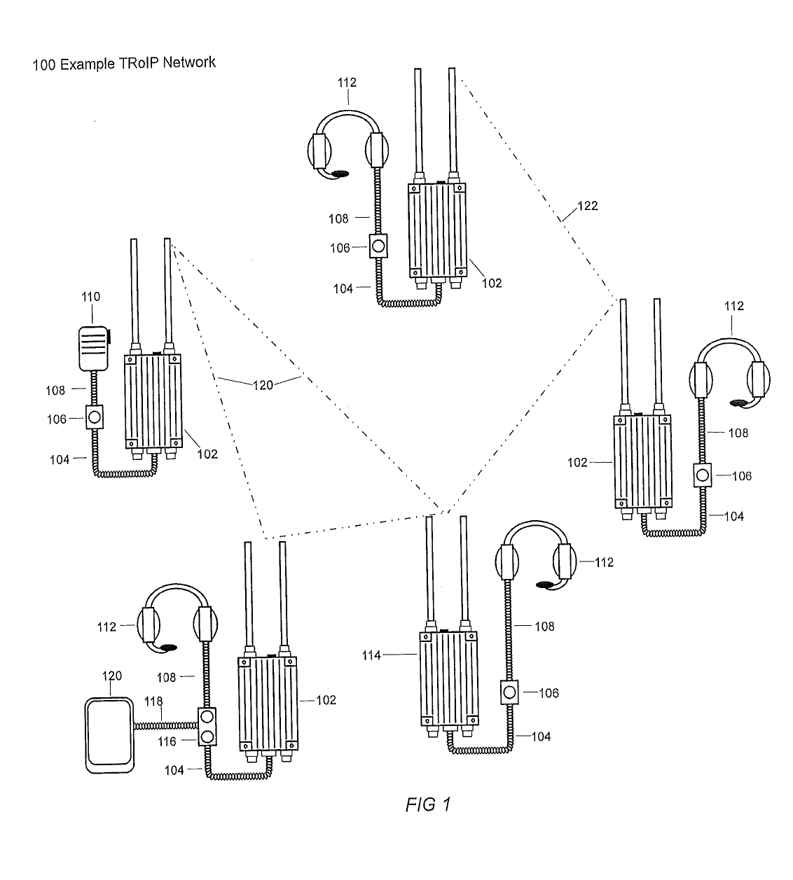

FIG. 1 details an example digital radio network running TRoIP 100. This is comprised of multiple radios 102, 114 in a peer-to-peer mesh connection. In such a mesh, any radio is able to communicate directly to any other, conditions permitting, but minimally, each radio must be able to communicate directly with at least one other in the same mesh. Each radio will have a digital port connection 104 running to a Push-to-Talk (PTT) interface module 106, 116. A simple PTT module will run an analog interconnect 108 to some kind of an audio I/O device. This may be a simple microphone/speaker handset 110, but the invention can offer additional functionality when the audio I/O device is a stereo headset 112 (by means of user configured preferences for individual conference assignment to a specific earpiece).

A main component of the TRoIP mixing system is the notion of logical Signal Groups. Each Group represents an independent conference. Any number of conferences may coexist on the same network, bound only by the limits on network bandwidth and use policies. An individual listener can participate in multiple conferences, the TRoIP configuration designates which conferences are mixed to either speaker in the stereo headset.

The PTT interface incorporates a push-to-talk button, which through the system directs the user's speech input to the primary conference channel. In the case of the stereo headset, this will address the primary conference on either the left or right side of the headset. A double-click of the PTT button 106, 116 will direct subsequent PTT input to the primary conference on the other side of the headset, eg, switch left to right or right to left.

The invention also supports an external auxiliary device 120, which is connected to the radio and PTT interface through an analog or digital interconnect 118. The PTT module for use with an auxiliary device 120 will have a secondary push button 116, which is used to direct speech from the audio I/O device 110, 112 to the auxiliary device, rather than the radio. The auxiliary device 120 may be a computer, tablet, or smartphone, used for configuration of the TRoIP system, and optionally, as a secondary means of communication. This allows a single headset to be shared between the network node and the secondary device.

While not visible to the observer, most of the network devices 102 in any TRoIP network will be client-only devices. At least one, however, will be designated as the Mix-Master 114. Each device has the ability to be elected by its peers in the network to be the Mix-Master by means of an incorporated computer system embedded in a microchip. This function will be discussed in detail, as well as the election process that allows regular addition and loss of network nodes without any significant disruption to communications within the active network.

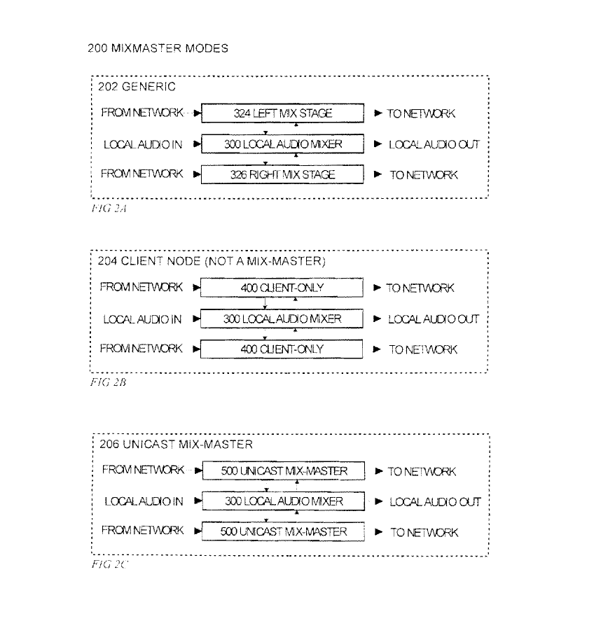

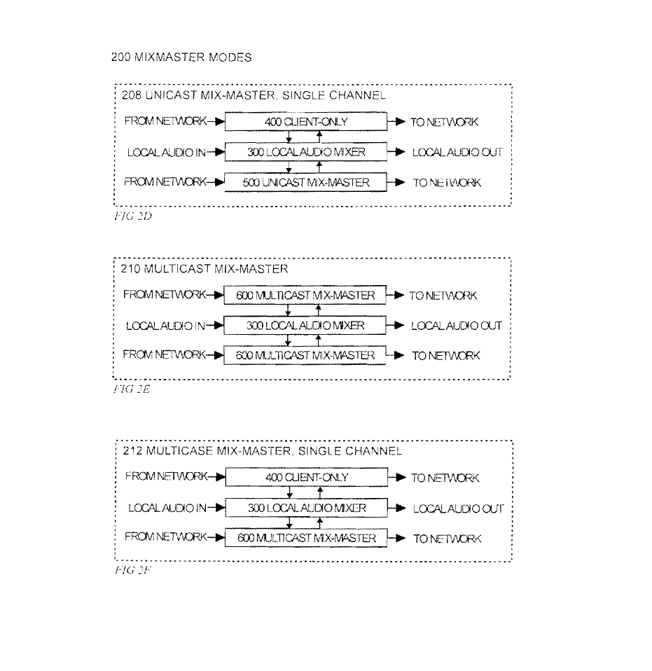

FIGS. 2a-2f illustrate the various possible modes of the audio mixing module within the invention. Note well that all mixing stages are implemented in software. As such, the number of channels for any given mixer or signal tee can be essentially any width, as dictated by the specifics for the individual node in question: the left/right configuration, the number of Signal Groups selected, etc.

As the system is designed to work on any peer-to-peer network, there is no concept of a permanent master node. And yet, for an audio conferencing system, all client audio input must be mixed at some central point, then distributed to every relevant client. The invention does this by including the full mixer logic in every node, then selecting one node as the Mix-Master, by means of an election process occurring between the various nodes. This is done by an election process that will be described in more detail below. A system will hold such an election when there is no Mix-Master, such as when a mesh network is initially established, split in two, and again when two independent networks are merged, ensuring that there is only one version of each channel/group available on the network.

The generic logic 202 of the mixer is illustrated in FIG. 2a. The Local Audio Mixer 300 module is effectively the same for all modes. There are two modal mixing stages, Left Mix Stage 324 and Right Mix Stage 326, which can handle the mix in a number of different modes. The simple rule is that the Local Audio Mixer has output to the stage mixer, and can mix in an input from the stage mixer.

A client-only node 204 is illustrated in FIG. 2b. In this case, both left and right stages are in client-only mode 400. FIG. 2c shows a Unicast Mix-Master node 206, in which both flexible stages are in Unicast Mix-Master mode 500. FIG. 2d illustrates that a node 208 can run as a Mix-Master for a single Unicast channel 500, the other channel running in client-only mode 400. And finally, FIG. 2e shows a node 210 in Multicast Mix-Master mode 600, with FIG. 2f illustrating a node 212 running Multicast Mix-Master 600 on just one channel, the other in client-only mode 400.

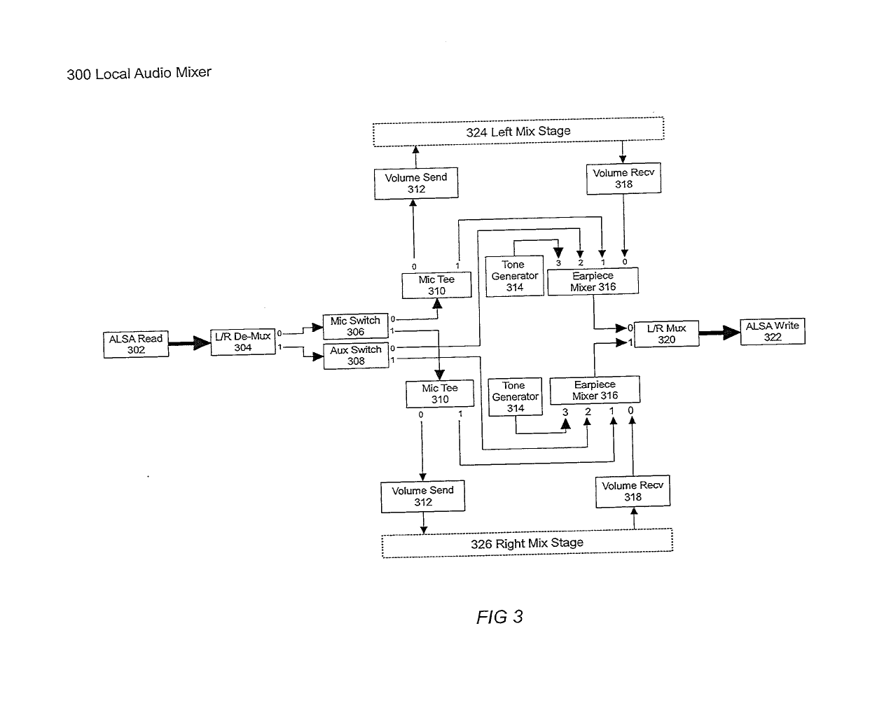

FIG. 3 illustrates a detailed block diagram of the Local Audio Mixer 300. Audio from the local hardware subsystem is brought in via an operating system level device driver. In the preferred implementation, this is a driver for the Advanced Linux Sound Architecture (ALSA) 302, but the invention is fundamentally unchanged using any other driver model here. A multiplexed stereo stream from the driver 302 is demultiplexed 303 and set to microphone 306 and auxiliary 308 switches. The auxiliary audio switch 308 can direct auxiliary audio the earpiece mixer of either the left or right channel 316.

The microphone switch 306 can direct microphone audio to either the left or the right channel, the choice being determined logically by the user's prior channel selection, in the case of multiple conferences. The audio is passed first to a tee 310, which sends the microphone audio to the selected channel's earpiece mixer, and also to a volume control 312 and on to the flexible mixer stage 324, 326. As mentioned, this mixing stage is processing network audio of some kind, depending on the specific mode in use on any particular node. Audio leaving each flexible mixer stage 324, 326 enters the Local Audio Mixer 300 at another volume control 318, and goes on to the respective earpiece mixers 316.

A final input to each earpiece mixer is a tone generator 314. This tone generator 314 is driven by system level events, such as alerts and other sorts of audio interface queues to the listener.

The earpiece mixer outputs 316 from both left and right channels are merged into a stereo stream in the L/R Multiplexer 320, and sent to the operating system's audio output driver. In the preferred embodiment, as before, this is an ALSA driver, but the same functionality would exist in any other operating system.

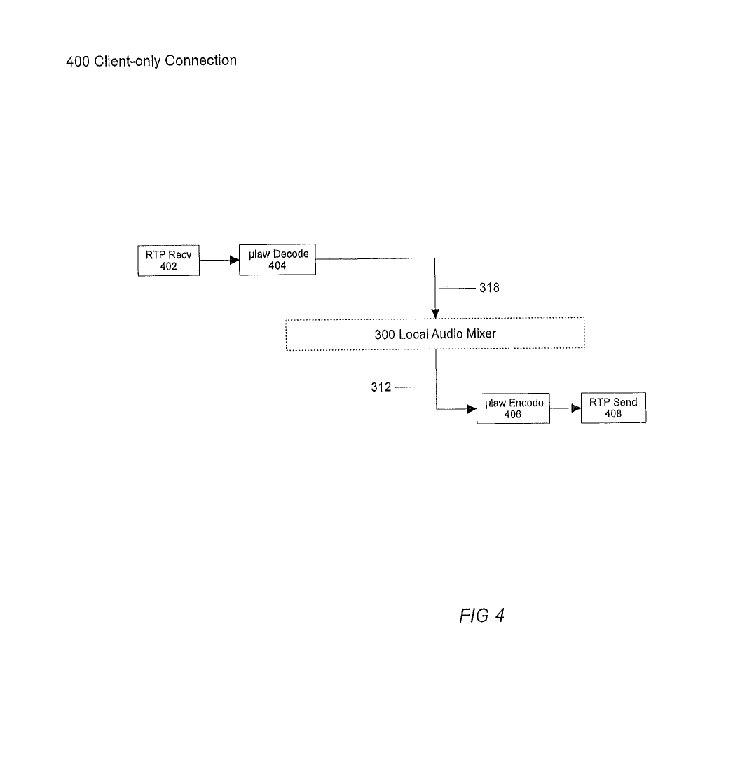

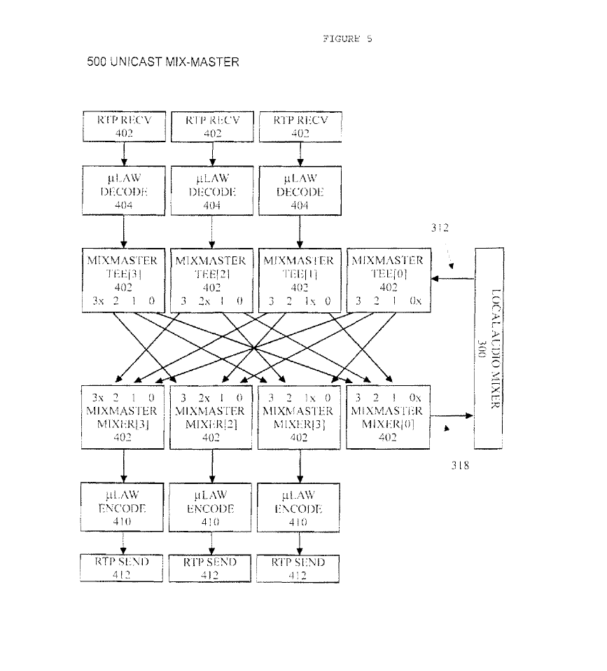

FIG. 4 illustrates the block diagram 400 of the client-only mode of the flexible stage mixer. This is the very simple case. Audio from the network in use is routed via a suitable realtime media protocol to the system 402. The preferred embodiment is using the Realtime Transport Protocol (RTP), however, any efficient media streaming protocol could replace the RTP block at 402. In the preferred embodiment, the audio is encoded as speech-quality audio with μ-Law companding, and it must be restored to a linear format prior to mixing 404, however, this would function with linear audio or other forms of audio compression, as the architecture expands audio prior to the mixer. The output of this goes to the input 318 of the Local Audio mixer.

For audio sourced out of the Local Audio Mixer 312, it is necessary to compand back to μ-Law for routing over the network 406. And this is put on the network using RTP as the transport 408, though as before, other efficient media transport protocols would work here as well.

FIG. 5 illustrates the block diagram 500 of the Unicast Mix-Master. As discussed, for every Signal Group, one node in the system is elected as a Mix-Master. A Mix-Master node will have one audio stream entering over the media transport protocol 402 for each channel that it's mixing, other than the local audio for that node. The audio streams are all linearized from μ-Law 404, and routed to the Mix-Master tees 502. There will be one tee for each audio channel, including the audio entering from the Local Audio Mixer 312.

Audio from each tee is cross routed to an equal number of per-channel Mix-Master Mixers 504. Each of these mixers will independently feed the input of another TRoIP node, so each Mixer can use different configuration data to determine which signals actually get mixed here. Each Mixer 504 is routed to a μ-Law encoder 410, and sent to its destination unit via an RTP encapsulation 412.

Thus, for an N-channel TRoIP conference there will be N−1 RTP network inputs fed to N μ-Law decoders and on to N Mix-Master tees, N Mix-Master Mixers, and N−1 μ-Law encoders feeding N RTP network outputs. The final input to the mixer is via the Local Audio Mixer output 312, and the final output from the Mix-Master Mixer is sent to the Local Audio Mixer input 318.

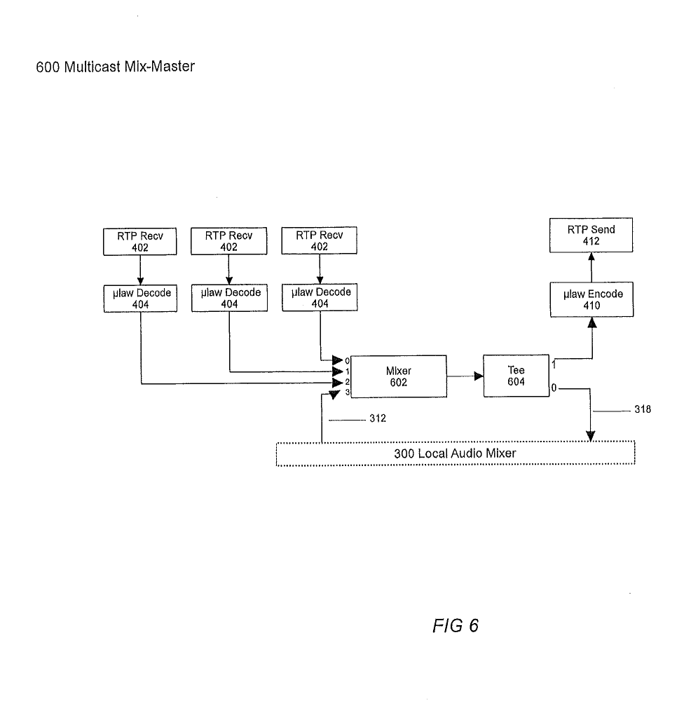

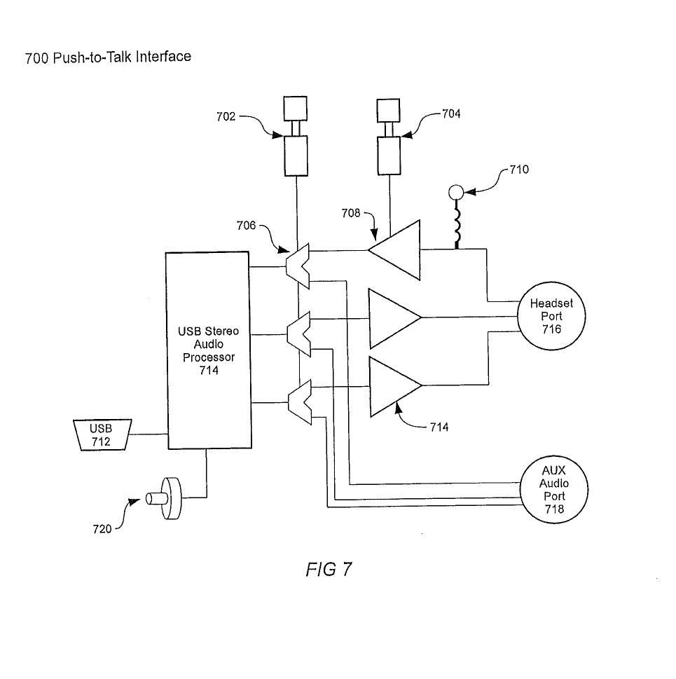

FIG. 6 illustrates an alternate form of the Mix-Master, this for a Mix-Master using IP Multicast 600 as the audio output. The input section of this is still accessing N−1 RTP network inputs 402 routed to N−1 μ-Law decoders 404. These N−1 linearized channels then route to a single mixer 602, joined by audio from the local node 312. This mixer 602 then feeds a tee, which routes the mixer's output directly to the local audio input 318, and as well to a μ-Law encoder 410 and out to the network via RTP broadcast 412. Given the broadcast nature of this, this will be routed exactly the same to every node in the network, with no option for individual mixes or other settings.

FIG. 7 illustrates a typical Push-to-Talk (PTT) interface 700 for the TRoIP system. This is based on a USB interface 712 to the mesh radio system, and a fairly standard USB audio processor 714. A headset or handset is attached to the PTT module at the Headset Port 716. This provides a single microphone input with bias 710, and two channel audio output. A microphone preamp 708 will typically condition the input audio, while a driver amplifier 714 delivers higher level audio to the user's phones or speaker.

The PTT interface is managed via two push buttons 702, 704. The actual push-to-talk button 704 will indicate to the radio system that the user is transmitting. In cooperating with the radio unit software, a double-keying of the PTT button will change the routing of the microphone, in the case in which the user is a member of more than one conference group. The system's tone generator (314, see FIG. 3) acts as part of this user interface by immediately acknowledging such changes to the user's headset.

An option on the PTT interface is a single volume control 720. This control works in conjunction with the local node mixer software. It will adjust the gain of the microphone when the talk button is keyed. Otherwise, it will adjust the relative audio level of the current default conference.

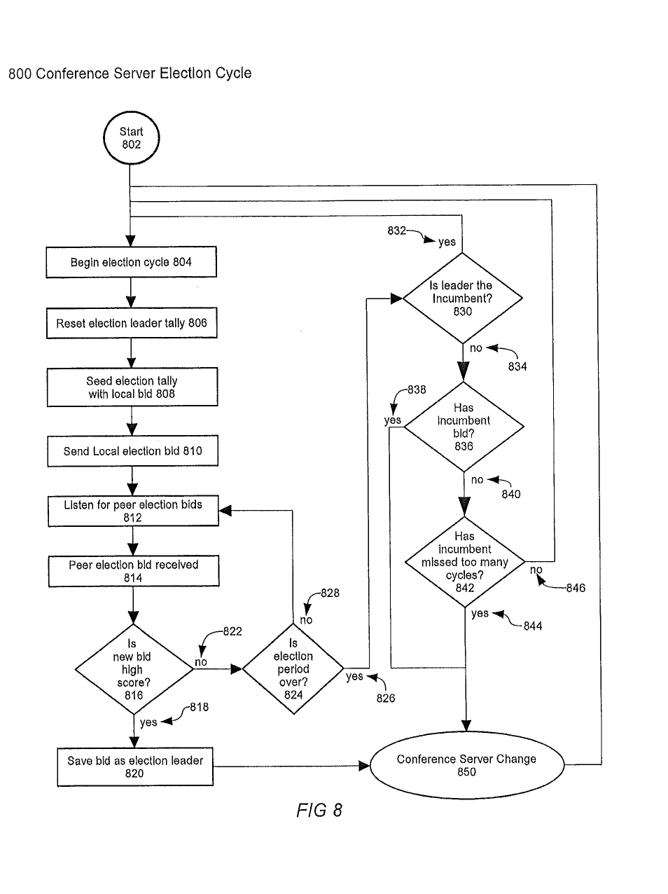

FIG. 8 illustrates a basic Conference Server (aka Mix-Master) Election Cycle flowchart 800. The cycle starts 802 based on a periodic update, the loss of the current server, the start of a conference cycle, or possibly other stimulus. The start of the cycle 804 causes election tallies to be reset 806. The local node will bid and start the local tally 808, then send the local bid to other nodes in the conference 810.

The criteria for each nodes' bids will be based on the specific nature of the underlying network. In a static peer to peer network, this might simply be first come, first served. On a highly mobile mesh network, data from the mesh (proximity and quality of node-to-node links, etc) can inform the bidding process.

The local node listens for peer election bids 812, eventually receiving some 814. These are added to the bid tally, and checked for a new high score 816. If the current high score has changed, the corresponding node is marked as the election leader 820, and the conference server change is made 850.

With no change in high score 822, the system checks if the election period is over. If not, more bids are analyzed 828. If so, the local node checks to see if the current leader is the incumbent Mix-Master 830. If so, the election is over, with no change in Mix-Master 832.

If the leader is not the incumbent 834, we check if the incumbent has placed bids 836, indicating that the network can hear the current Mix-Master. If so, then the incumbent has simply lost the election 838, and the system calls for a change in the conference server 850.

If the incumbent hasn't bid, we check to see if the incumbent has been present for at least a threshold count of cycles 842. If the incumbent is missing too many cycles 844, the conference server is changed 850. Otherwise 846, the election cycle is reset 846.

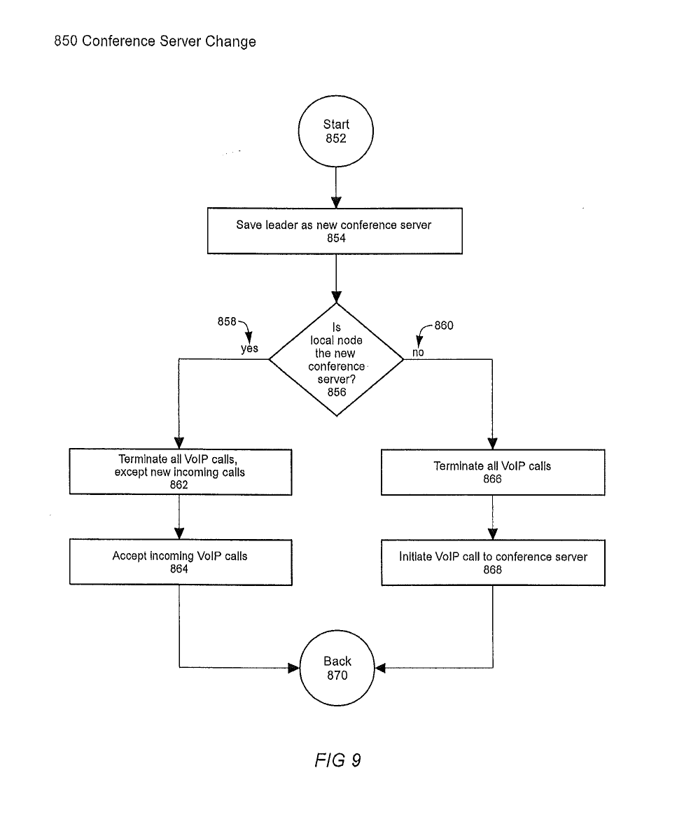

The actual Conference Server Change 850 flowchart is described in FIG. 9. This starts 852 with the election leader set as the new conference server 854. This is happening on all conference nodes. This selection is checked against the local node ID 856. If the local node is now the conference server, existing current VoIP calls are terminated 862, and the node is put into the appropriate Mix-Master mode and set to start accepting new VoIP calls 864. If the node is just a client, it terminates all VoIP calls 866, then starts all new calls to the new server 868, then we're back to the election loop 870, 802.

While a preferred embodiment has been set forth above, those skilled in the art who have reviewed the present disclosure will readily appreciate that other embodiments can be realized within the scope of the invention. For example, the invention can be used with any suitable network and network protocol. Therefore, the present invention should be construed as limited only by the appended claims.

What is claimed is:

1. A method for voice conferencing over a network, the method comprising:
(a) providing a plurality of conferencing nodes, each of said plurality of conferencing nodes being programmed with voice conferencing software such that the node is capable of said voice conferencing over the network and is also capable of functioning as a conference server;
(b) automatically evaluating the network at each node;
(c) automatically determining one of the nodes that is best connected to the network in accordance with a result of step (b); and
(d) selecting said one of the nodes to act as the conference server in accordance with a result of step (c).

2. A method as in claim 1, wherein the network is a dynamic, mobile mesh network having a mesh subsystem, and wherein step (d) is performed also in accordance with data from the mesh subsystem.

3. A method as in claim 1, further comprising (e) grouping the nodes into logical call groups, wherein:
(i) each call group constitutes a separate, independent voice conference;
(ii) each call group can contain any of the nodes;
(iii) each of the nodes can be a member of any number of the call groups; and
(iv) the call groups can be assigned priorities, allowing mixing or overriding content from other ones of the call groups.

4. A method as in claim 3, wherein step (e) comprises implementing a configuration user interface, allowing the call groups and properties and rules of the call groups to be pre-defined prior to a job or mission and modified by a suitable peripheral device in the field.

5. A method as in claim 3, wherein each of the nodes comprises a microphone, a left headphone, a right headphone, and a hardware push-to-talk interface with a talk button, and wherein each of the nodes is configured such that:
(i) call group audio is selectively mixed to left or right headphone;
(ii) the call group audio is mixed between each of the call groups and also with local radio-based sources of audio;
(iii) activation of the talk button causes the microphone to act as an input to a current default call group; and
(iv) double-clicking of the talk button changes the current default call group, while the voice conferencing software provides audible feedback to the user to indicate that the current default call group has been changed.

6. A method as in claim 5, wherein the local radio-based sources of audio comprise at least one of a user's vocal feedback and alert signals.

7. A method as in claim 5, further comprising (f) interfacing a user input device to the node.

8. A method as in claim 7, wherein the user input device comprises at least one of a computer, a tablet, and a smartphone

9. A method as in claim 7, wherein step (f) comprises digitally interfacing the user input device to the node.

10. A method as in claim 7, wherein step (f) comprise analog interfacing the user input device to the node.

11. A method as in claim 7, wherein the push-to-talk interface comprises a button to allow audio to/from the user interface device to be routed to/from the user's headset, in lieu of audio from the network.

12. A method as in claim 1, wherein the network is an Internet Protocol network.

13. A node for voice conferencing over a network, the node comprising:
a communication component for audio communication with the network;
an audio component for allowing a user of the node to participate in the audio connection; and
a processor programmed with voice conferencing software for:
(a) voice conferencing over the network and also functioning as a conference server;
(b) automatically evaluating the network;
(c) automatically determining one of a plurality of other nodes on the network that is best connected to the network in accordance with a result of step (b); and
(d) selecting said one of the nodes to act as the conference server in accordance with a result of step (c).

14. A node as in claim 13, wherein the network is a dynamic, mobile mesh network having a mesh subsystem, and wherein the processor is configured to perform step (d) also in accordance with data from the mesh subsystem.

15. A node as in claim 13, wherein the processor is further programmed for (e) grouping the nodes into logical call groups, wherein:
(i) each call group constitutes a separate, independent voice conference;
(ii) each call group can contain any of the nodes;
(iii) each of the nodes can be a member of any number of the call groups; and
(iv) the call groups can be assigned priorities, allowing mixing or overriding content from other ones of the call groups.

16. A node as in claim 15, wherein the processor is programmed to perform step (e) by implementing a configuration user interface, allowing the call groups and properties and rules of the call groups to be pre-defined prior to a job or mission and modified by a suitable peripheral device in the field.

17. A node as in claim 15, wherein:
the audio component comprises a microphone, a left headphone, a right headphone, and a hardware push-to-talk interface with a talk button; and
the processor is programmed such that:
(i) call group audio is selectively mixed to left or right headphone;
(ii) the call group audio is mixed between each of the call groups and also with local radio-based sources of audio;
(iii) activation of the talk button causes the microphone to act as an input to a current default call group; and
(iv) double-clicking of the talk button changes the current default call group, while the voice conferencing software provides audible feedback to the user to indicate that the current default call group has been changed.

18. A node as in claim 17, wherein the local radio-based sources of audio comprise at least one of a user's vocal feedback and alert signals.

19. A node as in claim 17, further comprising an interface for interfacing a user input device to the node.

20. A node as in claim 19, wherein the interface for interfacing is configured such that the user input device comprises at least one of a computer, a tablet, and a smartphone

21. A node as in claim 19, wherein the interface for interfacing is configured for digitally interfacing the user input device to the node.

22. A node as in claim 19, wherein the interface for interfacing is configured for analog interfacing the user input device to the node.

23. A node as in claim 19, wherein the push-to-talk interface comprises a button to allow audio to/from the user interface device to be routed to/from the user's headset, in lieu of audio from the network.

24. A node as in claim 13, wherein the communication component is configured such that the network is an Internet Protocol network.
